(19) United States
(12) Patent Application Publication
(10) Pub. No.: US 2017/0083173 A1
(43) Pub. Date: Mar. 23, 2017

(54) SYSTEMS AND METHODS FOR INTERACTING WITH COMPUTING DEVICES VIA NON-VISUAL FEEDBACK

(71) Applicants: Daniel Novak, Prague (CZ); Petr Svobodník, Velke Bilovice (CZ)

(72) Inventors: Daniel Novak, Prague (CZ); Petr Svobodník, Velke Bilovice (CZ)

(21) Appl. No.: 14/863,154

(22) Filed: Sep. 23, 2015

(51) Int. Cl. G06F 3/0482; G06F 3/0484; G06F 3/16; G06F 3/0488

(52) U.S. Cl. CPC G06F 3/0482; G06F 3/04883; G06F 3/04842; G06F 3/167

(57) ABSTRACT

A method of interacting with a mobile device via non-visual feedback includes receiving a first location-independent gesture from a user via a touch screen of the mobile device. The user may be seeing-impaired or blind. The first location-independent gesture may be translated into a first computer-readable instruction via a processor of the mobile device. An audio response to the user may be provided in response to the first computer-readable instruction via an audio output device of the mobile device. In response to the audio response, a second location-independent gesture may be received from the user via the touch screen. The second location-independent gesture may be translated into a second computer-readable instruction via the processor of the mobile device. In response executing, the second computer readable instruction may be executed via the processor of the mobile device.

### BACKGROUND

The present disclosure relates generally to systems and methods of interacting with computing devices. In particular, systems and methods of interacting with computing devices via non-visual feedback are described. Such systems and methods may be of particular utility to blind and/or visually impaired users.

It is estimated that there are approximately 285 million visually impaired people worldwide, about 39 million of whom are completely blind. In the United States, it is estimated that there are approximately 20 million visually impaired people, about 1.3 million of whom are blind. In Europe, it is estimated that there are approximately 32 million visually impaired and 3 million blind. These individuals have been disadvantaged by the technological developments of mobile phone telephony, which since 2007 has dramatically moved toward the production of touchscreen smart phones. Though functionally superior for sighted users, smart phones present significant challenges for the visually impaired such as small text and icons, complex navigation structures, and difficult finger commands. These challenges make smart phones almost unusable for a large number of people. Thus, blind and/or visually impaired users are denied access to the advantages of current smart phone technology.

Known systems designed for visually impaired users to interact with computing devices, such as smart phones, are unsatisfactory for the range of applications in which they are employed. For example, existing systems require the user to create a different mental map for each separate application to be able to control the application. Typing using standard keyboard is very cumbersome for visually impaired users and requires considerable skills. Moreover, visually impaired users must touch a specific area of the screen to launch appropriate functions. These limitations create technological barriers for visually impaired users of computing devices.

Thus, there exists a need for systems and methods of interacting with computing devices that improve upon and advance the design of known such systems. Examples of new and useful systems relevant to the needs existing in the field are discussed below.

### SUMMARY

The present disclosure is directed to systems and methods of interacting with a computing device via non-visual feedback. In one example, a method of interacting with a mobile device includes receiving a first location-independent gesture from a user via a touch screen of the mobile device. The user may be seeing-impaired or blind. The first location-independent gesture may be translated into a first computer-readable instruction via a processor of the mobile device. An audio response to the user may be provided in response to the first computer-readable instruction via an audio output device of the mobile device. In response to the audio response, a second location-independent gesture may be received from the user via the touch screen. The second location-independent gesture may be translated into a second computer-readable instruction via the processor of the mobile device. In response executing, the second computer readable instruction may be executed via the processor of the mobile device.

### BRIEF DESCRIPTION OF THE DRAWINGS

FIG. 1 is a schematic illustration of one embodiment of a method of interacting with a computing device via non-visual feedback.

FIG. 2 is a schematic illustration of one embodiment of a navigation menu for a call mode of a computing device in accordance with the present invention.

FIG. 3 is a schematic illustration of one embodiment of a navigation menu for a SMS (text) message mode of a computing device in accordance with the present invention.

FIG. 4 is a schematic illustration of one embodiment of a navigation menu for accessing, saving and/or managing contacts saved in data storage of a computing device in accordance with the present invention.

FIGS. 5-7 are a schematic illustration of one embodiment of a navigation menu for accessing additional applications of a computing device in accordance with the present invention.

FIGS. 8-9 are a schematic illustration of one embodiment of a navigation menu for accessing and configuring device settings of a computing device in accordance with the present invention.

FIG. 10 is a schematic illustration of one embodiment of a navigation menu for accessing information about the state of a computing device in accordance with the present invention.

FIG. 11 is a schematic illustration of one embodiment of a navigation menu for accessing favorite contacts saved in data storage of a computing device in accordance with the present invention.

FIG. 12 is a schematic illustration of one embodiment of illustrates a navigation menu for accessing missed events, such as missed calls and SMS messages in a computing device in accordance with the present invention.

FIG. 13 is a schematic illustration of one embodiment of a computing device in accordance with the present invention.

FIG. 14 is a schematic illustration of one embodiment of a mobile device in accordance with the present invention.

### DETAILED DESCRIPTION

The disclosed mobile devices controlled via non-visual feedback, and methods of their use, will become better understood through review of the following detailed description in conjunction with the figures. The detailed description and figures provide merely examples of the various inventions described herein. Those skilled in the art will understand that the disclosed examples may be varied, modified, and altered without departing from the scope of the inventions described herein. Many variations are contemplated for different applications and design considerations; however, for the sake of brevity, each and every contemplated variation is not individually described in the following detailed description.

Throughout the following detailed description, examples of disclosed mobile devices controlled via non-visual feedback, and methods of their use, are provided. Related features in the examples may be identical, similar, or dissimilar in different examples. For the sake of brevity, related features will not be redundantly explained in each example. Instead, the use of related feature names will cue the reader that the feature with a related feature name may be similar to the related feature in an example explained previously. Features specific to a given example will be described in that particular example. The reader should understand that a given feature need not be the same or similar to the specific portrayal of a related feature in any given figure or example.

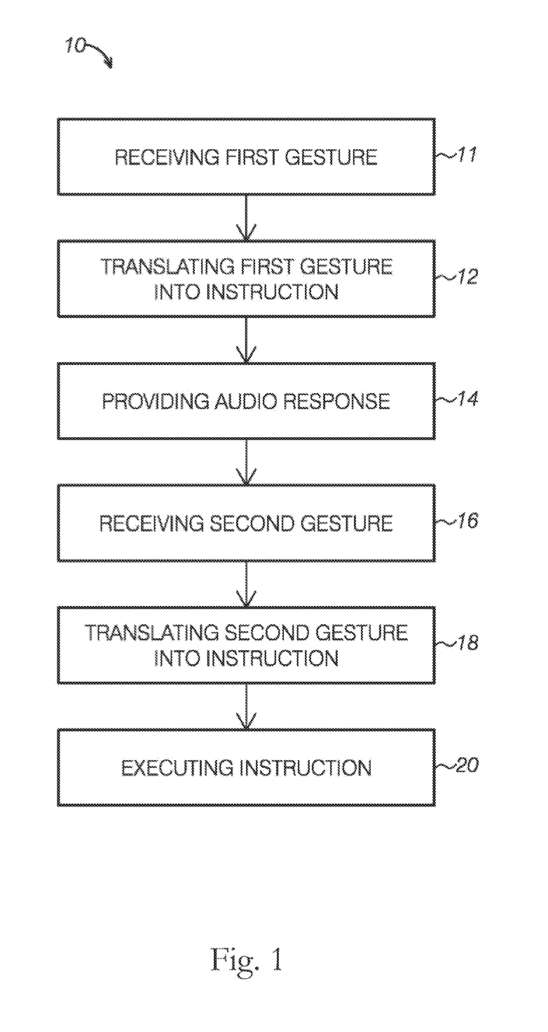

With reference to FIG. 1, a first example of a method of interacting with a mobile device (e.g., a smart phone) via non-visual feedback, method 10, will now be described. The disclosed method allows a user to provide input to a mobile device via a series of gestures made by the user's fingers on a touchscreen of the mobile device, absent any visual cues on the touchscreen. Furthermore, via the disclosed method, the mobile device may provide non-visual feedback to the user. The reader will appreciate from the figures and description below that method 10 addresses shortcomings of conventional mobile devices and methods of using them.

For example, method 10 allows a visually impaired or blind user to access and control the various menus and functions of the mobile device without the use of visual feedback to user.

Method 10 includes the steps of receiving 11 a first location-independent gesture from a user of a mobile device, translating 12 the first location-independent gesture into a first computer-readable instruction, providing 14 an audio response to the user, receiving 16 a second location-independent gesture from the user, translating 18 the second location-independent gesture into a second computer-readable instruction, and executing 20 the second computer-readable instruction.

The step of receiving 11 a first location-independent gesture from a user of a computing device (e.g., a mobile device) may comprise receiving the location-independent gesture via a touch screen of the computing device. As used herein, a “location-independent gesture” is a user input provided to a computing device comprising contact between a user's finger(s) and a touch screen of a computing device, wherein the precise location of the contact on touch screen is not a component of the user input. For example, a location-independent gesture may include touching the screen with two fingers anywhere on the screen. Furthermore, in some embodiments, a location-independent gesture may include touching anywhere on the right side of the touch screen. In some embodiments, a location-independent gesture may include touching anywhere on the right side of the touch screen. Thus, the reader may appreciate that touching a virtual button shown on a touch screen is not a location-independent gesture.

In some embodiments, the first and/or the second location-independent gesture may be selected from the group comprising: a one-finger tap on the right side of the touch screen; a one-finger tap on the left side of the touch screen; a one-finger push anywhere on the touch screen; a two-finger tap anywhere on the touch screen; a two-finger push anywhere on the touch screen; and a one-finger swipe from the bottom of the touch screen to the top.

In some embodiments, a “push” may be a contact of the touch screen having a greater duration than a “tap”. For example in some embodiments, a push may comprise a contact of the touch screen having a duration of at least 100 milliseconds. In some embodiments, a push may comprise a contact of the touch screen having a duration of at least 200 milliseconds. In some embodiments, a push may comprise a contact of the touch screen having a duration of at least 300 milliseconds. In some embodiments, a push may comprise a contact of the touch screen having a duration of at least 400 milliseconds. In some embodiments, a push may comprise a contact of the touch screen having a duration of at least 500 milliseconds. In some embodiments, a push may comprise a contact of the touch screen having a duration of at least 600 milliseconds. In some embodiments, a push may comprise a contact of the touch screen having a duration of at least 700 milliseconds. In some embodiments, a push may comprise a contact of the touch screen having a duration of at least 800 milliseconds. In some embodiments, a push may comprise a contact of the touch screen having a duration of at least 900 milliseconds. In some embodiments, a push may comprise a contact of the touch screen having a duration of at least 1,000 milliseconds.

In some embodiments, a tap may comprise a contact of the touch screen having a duration of not greater than 500 milliseconds. In some embodiments, a tap may comprise a contact of the touch screen having a duration of not greater than 400 milliseconds. In some embodiments, a tap may comprise a contact of the touch screen having a duration of not greater than 300 milliseconds. In some embodiments, a tap may comprise a contact of the touch screen having a duration of not greater than 200 milliseconds. In some embodiments, a tap may comprise a contact of the touch screen having a duration of not greater than 100 milliseconds. In some embodiments, a tap may comprise a contact of the touch screen having a duration of not greater than 50 milliseconds.

As the reader may appreciate, methods of providing input to a computing device via the location independent gestures described above may be particularly well suited to blind or seeing-impaired users. Such users may be incapable of discerning the various small virtual buttons illuminated on some touch screens of the prior art.

The step of translating 12 the first location-independent gesture into a first computer-readable instruction may be performed via a processor of the computing device. In some embodiments, the translating step 12 may comprise translating, via a processor of the computing device, a one-finger tap on the right side of the touch screen into a computer-readable instruction. For example, a one-finger tap on the right side of the touch screen may be translated into a computer-readable instruction to advance to a next item in a navigation menu of the mobile device.

In some embodiments, the translating step 12 may comprise translating, via a processor of the computing device, a one-finger tap on the left side of the touch screen into a computer-readable instruction. For example, a one-finger tap on the left side of the touch screen may be translated into a computer-readable instruction to revert to a previous item in a navigation menu of the mobile device.

In some embodiments, the touch screen may be divided into a left side and a right side via a vertical line bisecting the touch screen.

In some embodiments, the translating step 12 may comprise translating, via a processor of the computing device, a one-finger push anywhere on the touch screen into a computer-readable instruction. In some embodiments, the computer-readable instruction produced by the processor may depend, at least in part, on the current mode of the computing device. For example, when the mobile device is in a menu navigation mode, a one-finger push may be translated into a computer-readable instruction to confirm a current item in a navigation menu of the mobile device. In another example, when the mobile device is in a phone mode, a one-finger push may be translated into a computer-readable instruction to answer an incoming call. In yet another example, when the mobile device is in an alarm mode, a one-finger push may be translated into a computer-readable instruction to stop an alarm.

In some embodiments, the translating step 12 may comprise translating, via a processor of the computing device, a two-finger tap anywhere on the touch screen into a computer-readable instruction to repeat an audio response. In some embodiments, the computer-readable instruction produced by the processor may depend, at least in part, on the current mode of the computing device. For example, when the mobile device is in a menu navigation mode, a two-finger tap may be translated into a computer-readable instruction to repeat an audio response. In another example, when the mobile device is in a phone mode, a two-finger tap may be translated into a computer-readable instruction to provide audio caller information. In yet another example, when the mobile device is in a menu navigation mode, a two-finger push may be translated into a computer-readable instruction to revert to a previous menu. In another example, when the mobile device is in a phone mode, a two-finger push may be translated into a computer-readable instruction to dismiss an incoming call. In yet another example, when the mobile device is in an alarm mode, a two-finger push is translated into a computer-readable instruction to snooze an alarm.

The step of providing 14 an audio response to the user may be triggered via the computer-readable instruction produced in the translating step 12. In some embodiments, the audio response may comprise a text-to-speech announcement produced via an audio output device of the computing device. For example, the audio response may comprise a text-to-speech announcement of a current selection in a list of selections. In other embodiments, the computer-readable instruction produced in the translating step 12 may trigger another non-visual form of feedback from the computing device. For example, the non-visual response may comprise one or more vibrations produced via a vibrating device of the computing device.

The step of receiving 16 a second location-independent gesture from the user may include similar or identical features to the step of receiving 11 a first location-independent gesture. Thus, for the sake of brevity, those related features discussed above will not be redundantly explained. In some embodiments, the second location-independent gesture is the same as the first. In other embodiments, the second location-independent gesture is different than the first location-independent gesture.

The step of translating 18 the second location-independent gesture into a second computer-readable instruction may include similar or identical features to the step of translating 12 the first location-independent gesture. Thus, for the sake of brevity, those related features discussed above will not be redundantly explained.

The step of executing 20 the second computer-readable instruction may be completed via the processor of the computing device. The executing step 20 may comprise, for example, selecting an item in a navigation menu of the mobile device, dialing a contact, sending a message, selecting a character to insert in a text message, deleting a contact, and/or deleting a character in a text message among many others.

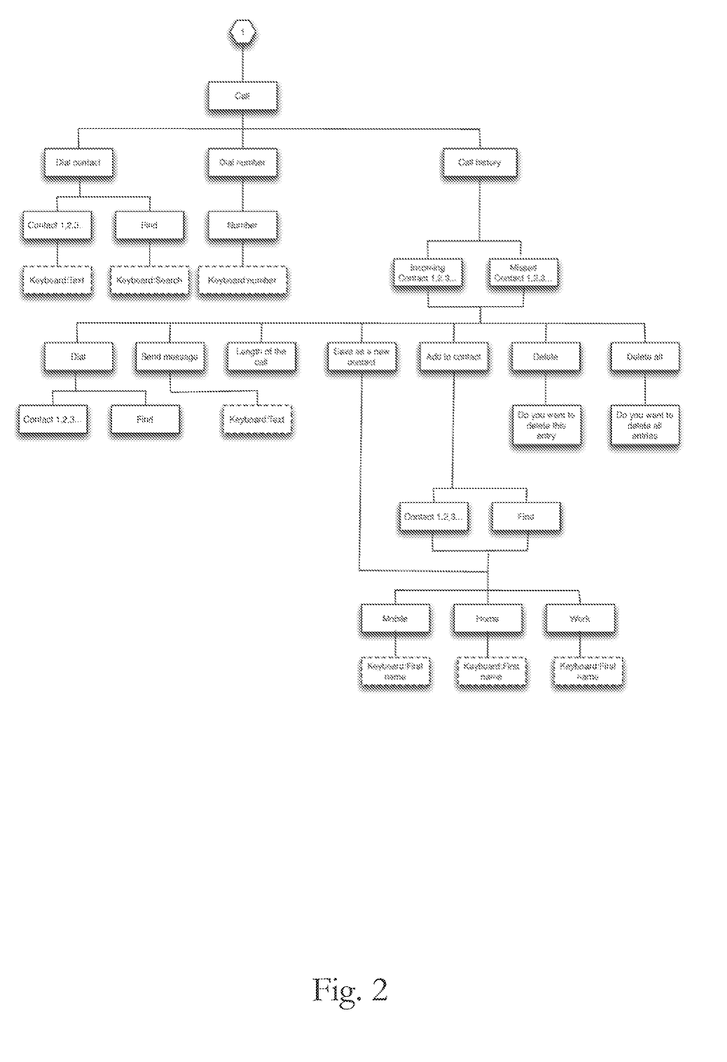

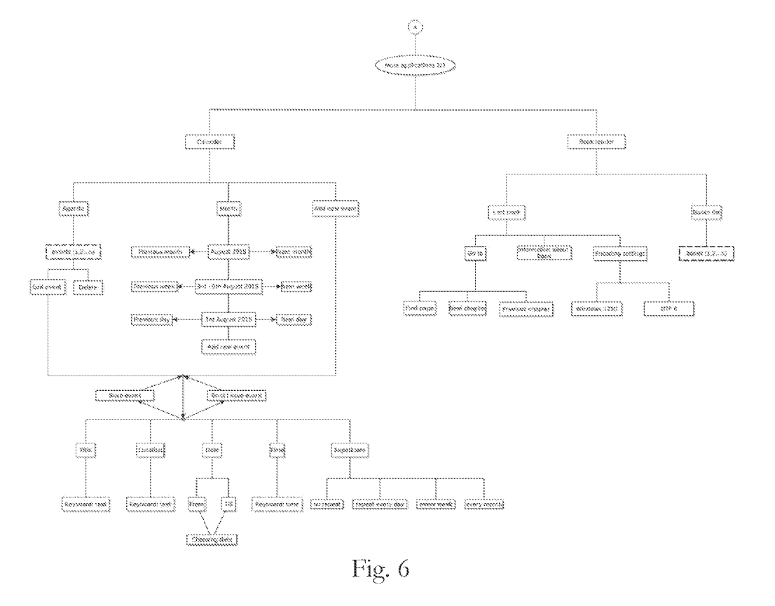

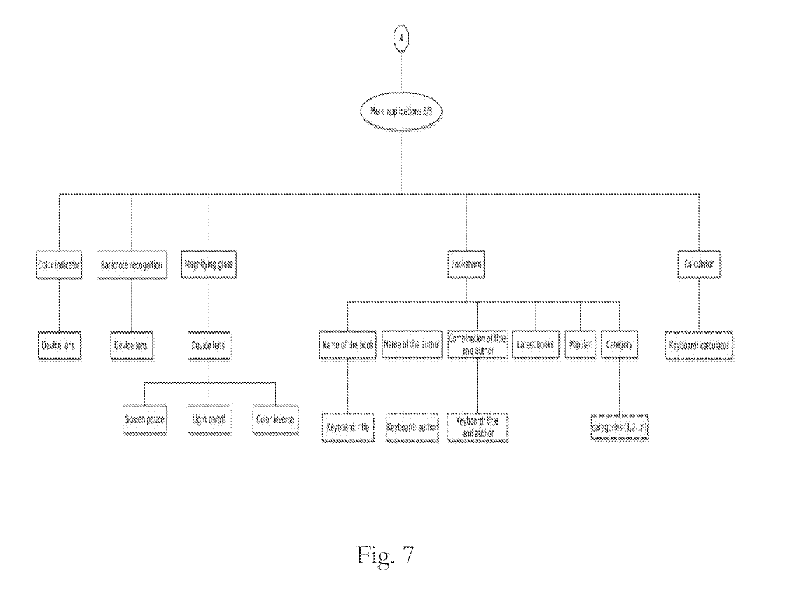

Turning attention to FIGS. 2-12, one example of a navigation menu scheme of the present invention will now be described. A user may navigate through the illustrated menu via non-visual feedback using the methods described above.

FIG. 2 illustrates a navigation menu for a call mode of a mobile device in accordance with the present invention. As can be seen in FIG. 2, the illustrated menu includes access to contacts and call history as well as numeric dialing capabilities.

Thus, in some embodiments, the present invention may include a touch screen keyboard function for text and numeric input in several different modes (call, messages, and notes among others). In some embodiments, the touch screen is divided into 12 sections. For example, when the touch screen may be divided into 3 columns and 4 rows, thus making 12 sections.

Each of the different sections of the touch screen may correspond to one or more alpha-numeric characters. For example the section located in the first row and second column may correspond to the number “2” as well as the letters “a”, “b”, and “c”. Furthermore, the section located in the first row and third column may represent the number “3” as well as the letters “d”, “e”, and “f”, and so on for the rest of the sections.

In some embodiments, the touch screen may be flat and smooth, and thus lacking tactile indicators of the locations of the different sections. Thus, a blind or seeing-impaired user may desire some type of feedback regarding the locations of the various sections.

In this regard, the text and or numeric input method may be based on an “explore and confirm” method. For example the user may slide one finger (e.g., a middle finger) on a touch screen of a computing device (e.g., a mobile device). In response, the computing device may provide audio feedback, via an audio output device of the computing device, to the user regarding which section of the touch screen the user's finger is currently touching. For example, the user may slide his finger to the section located in the first row and second column of the touch screen and the computing device may provide an audio response comprising “two”. In some embodiments, the user may confirm the selection by removing his finger from the touch screen.

As described above, in some embodiments, each section may correspond to more than one character. In this regard, the user may cycle through the characters corresponding to a specific section. For example, the user may slide a first finger (e.g., a middle finger) on the touch screen to the first row and second column of the touch screen and the computing device may provide an audio response comprising “two” in response, as described above. Then, to cycle through the other characters corresponding to the first row and second column, the user may tap another linger (e.g., an index finger) on the touch screen to cycle to the next character corresponding to the first row and second column. In response, the computing device may provide an audio response of “a”, and so on. In some embodiments, the user may confirm the selection by removing the first finger from the touch screen.

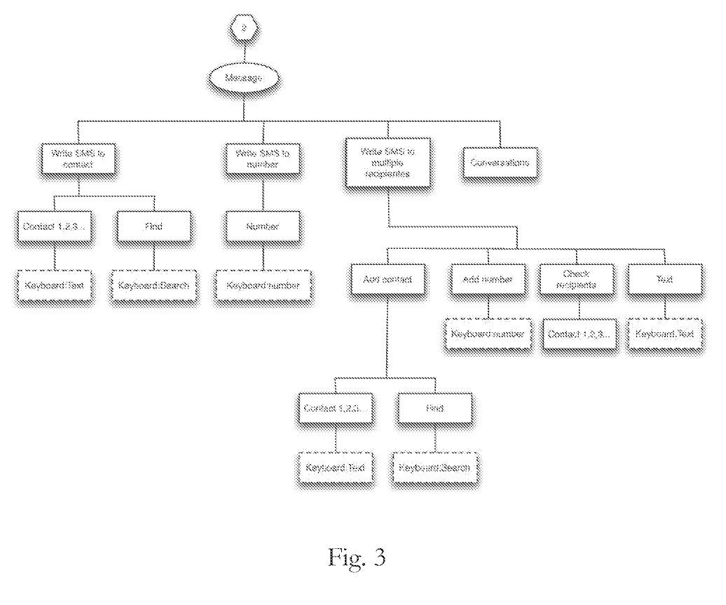

FIG. 3 illustrates a navigation menu for a SMS (text) message mode of a computing device (e.g., a mobile device) in accordance with the present invention. As can be seen in FIG. 3, the illustrated menu includes items for texting directly to saved contacts as well as group texting and texting direct to a phone number.

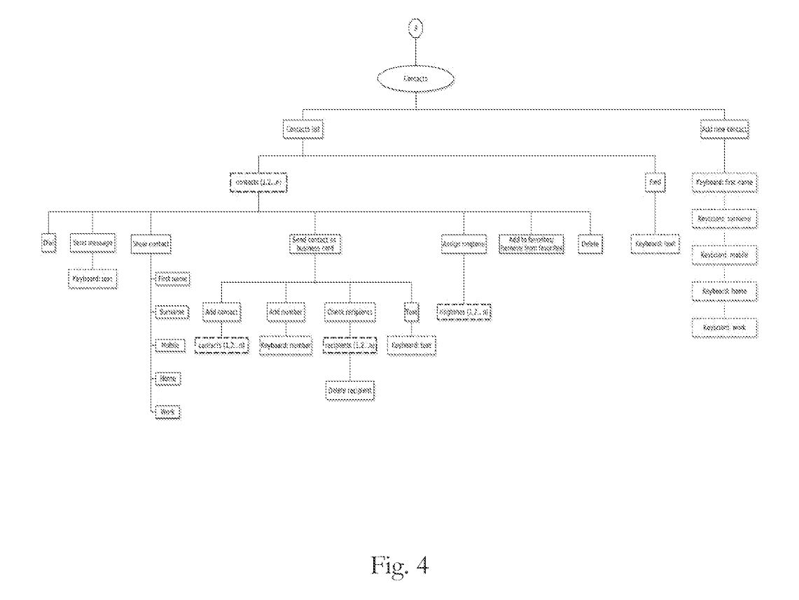

FIG. 4 illustrates a navigation menu for accessing, saving and/or managing contacts saved in data storage of a computing device (e.g., a mobile device) in accordance with the present invention. As can be seen in FIG. 4, the illustrated menu includes items for accessing a saved contact, finding a saved contact and adding a new contact.

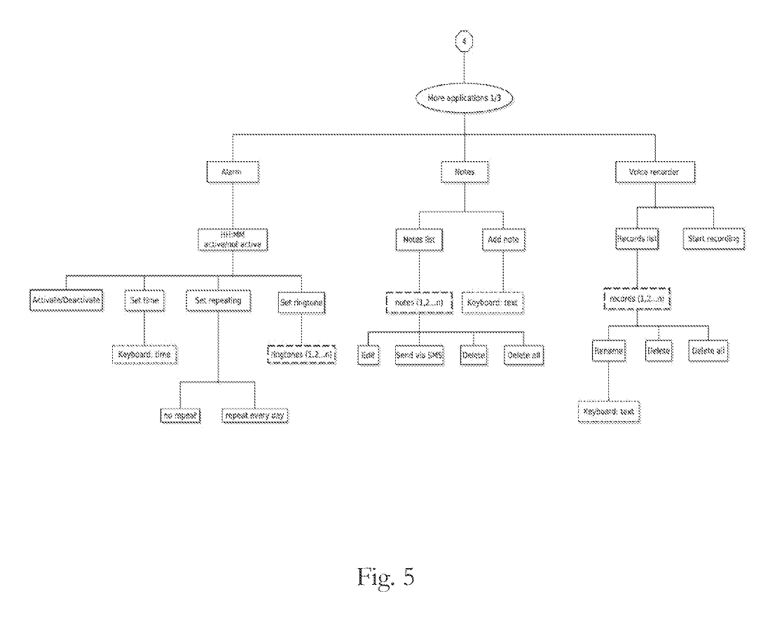

FIGS. 5-7 illustrate a navigation menu for accessing additional applications of a computing device (e.g., a mobile device) in accordance with the present invention. As can be seen in FIGS. 5-7, the illustrated menu includes such applications as an alarm, notes, a voice recorder, a calendar, a book reader, a color indicator, a banknote recognition application, a magnifying glass, a bookshare application and a calculator.

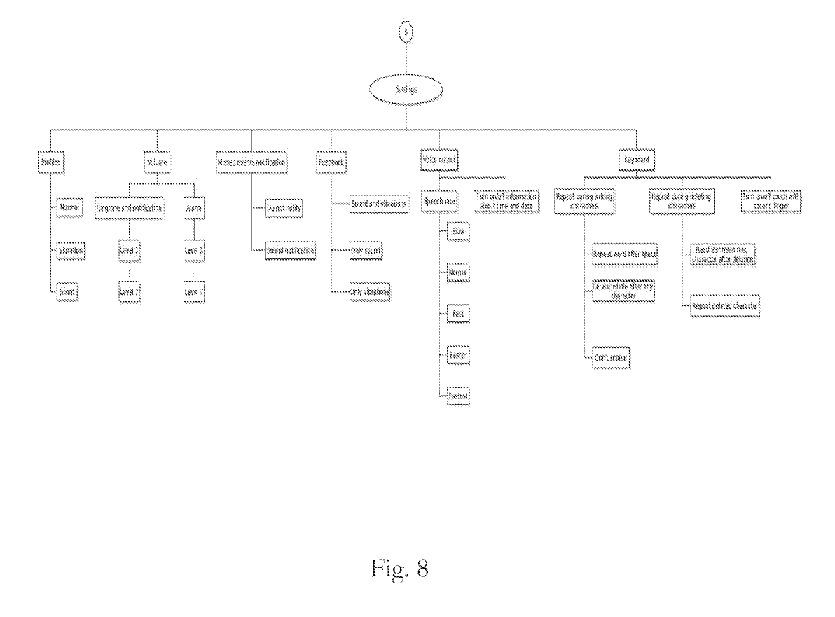

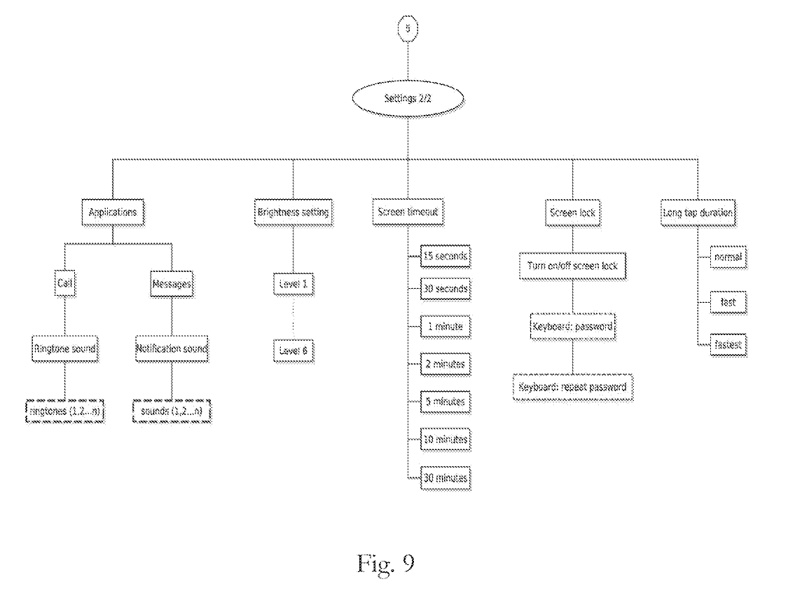

FIGS. 8-9 illustrate a navigation menu for accessing and configuring device settings of a computing device (e.g., a mobile device) in accordance with the present invention. As can be seen in FIGS. 8-9, the illustrated menu includes items for configuring the audio feedback and tap duration.

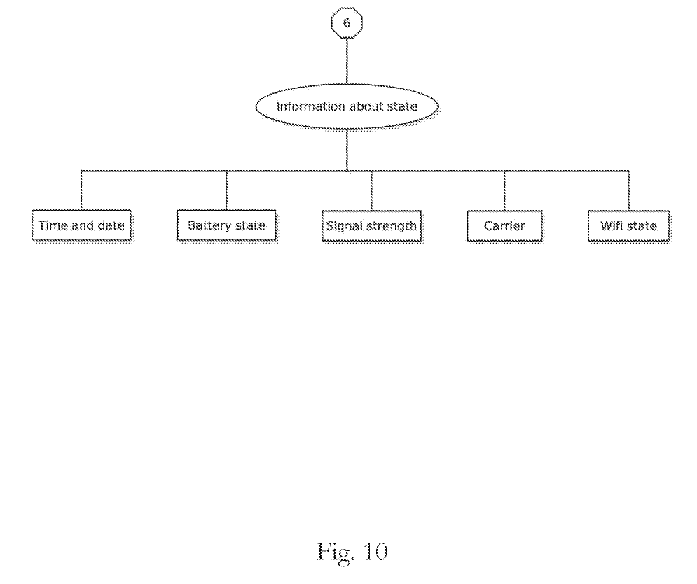

FIG. 10 illustrates a navigation menu for accessing information about the state of the phone. As can be seen in FIG. 10, the illustrated menu includes items for accessing information about the time and date, the state of the battery of the computing device, the signal strength of one or more networks available to the computing device, and the network carrier.

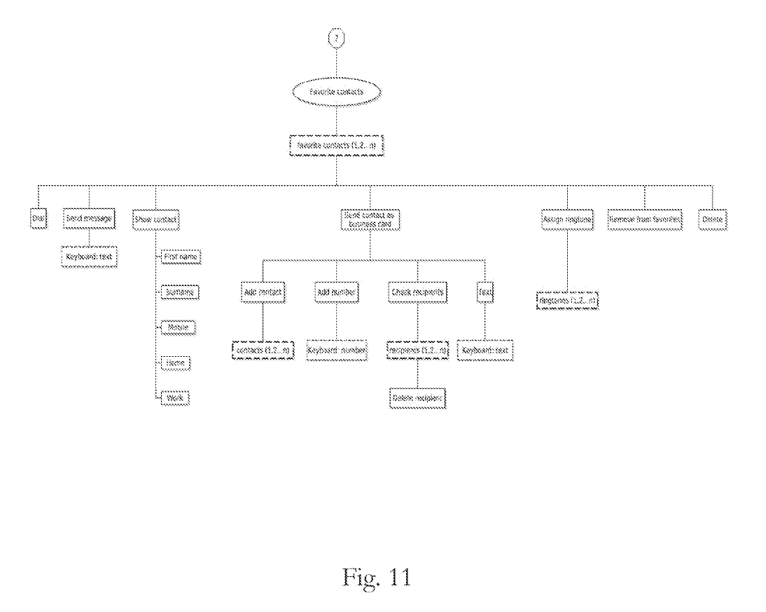

FIG. 11 illustrates a navigation menu for accessing favorite contacts saved in data storage of the computing device. As can be seen in FIG. 11, the illustrated menu includes items for sending a message, sending a contact, and removing a contact from favorites.

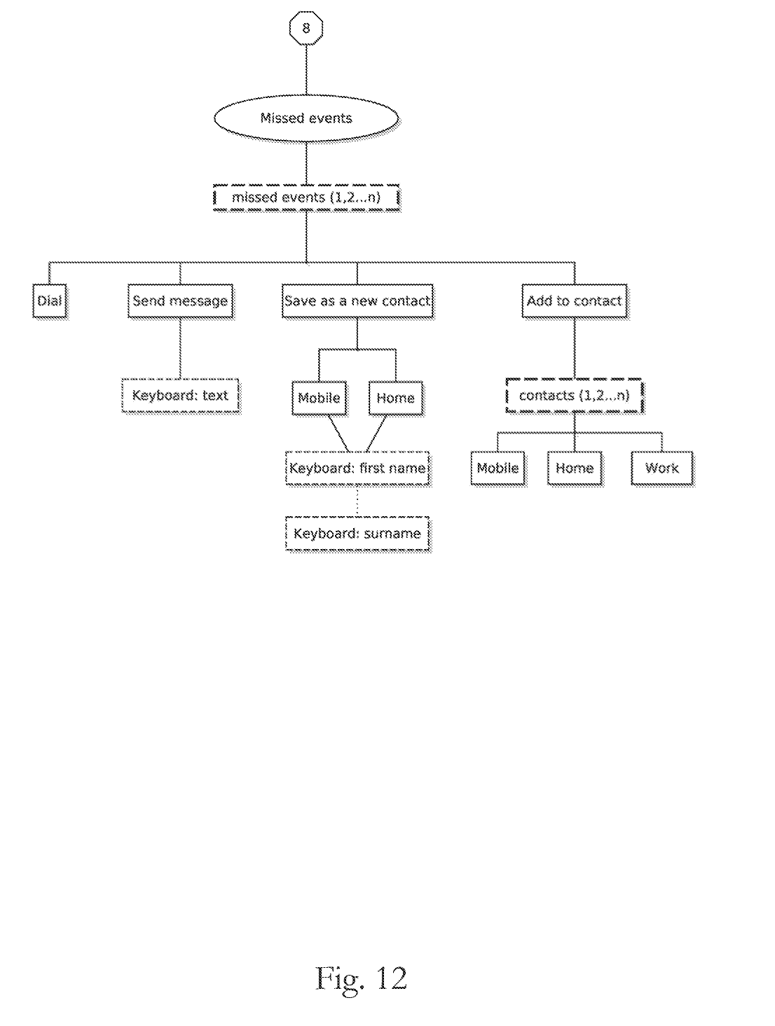

FIG. 12 illustrates a navigation menu for accessing missed events, such as missed calls and SMS messages. As can be seen in FIG. 12, the illustrated menu includes items for dialing the sender of a missed call/message, saving the missed number as contact and adding the number to an existing contact.

The above described methods of interacting with computing devices via non-visual feedback may be employed to control or interact with a variety of computing devices (e.g., mobile devices). In this regard, it will be appreciated that various disclosed examples may be implemented using electronic circuitry configured to perform one or more functions. For example, with some embodiments of the invention, the disclosed examples may be implemented using one or more application-specific integrated circuits (ASICs). More typically, however, features of various examples of the invention will be implemented using a programmable computing device executing firmware or software instructions, or by some combination of purpose-specific electronic circuitry and firmware or software instructions executing on a programmable computing device.

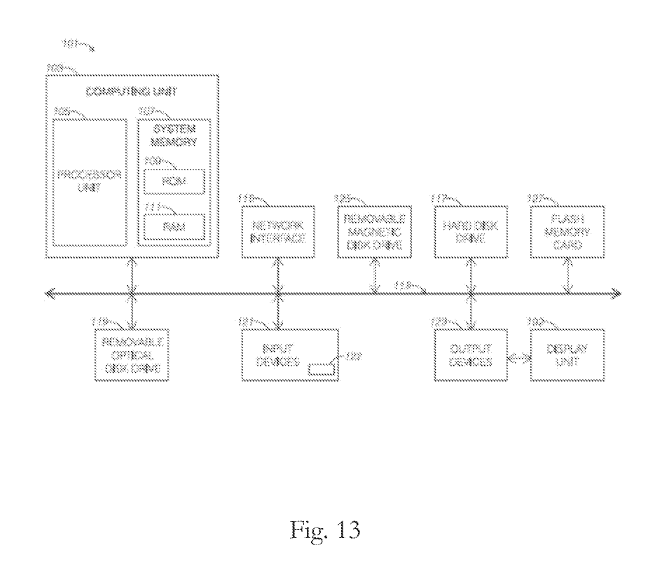

Accordingly, FIG. 13 shows one illustrative example of a computing device, computing device 101, which can be used to implement various embodiments of the invention. Computing device 101 may be incorporated within a variety of consumer electronic devices, such as personal media players, cellular phones, smart phones, personal data assistants, global positioning system devices, smart eyewear, smart watches, other computer wearables, and the like.

As seen in this figure, computing device 101 has a computing unit 103. Computing unit 103 typically includes a processing unit 105 and a system memory 107. Processing unit 105 may be any type of processing device for executing software instructions, but will conventionally be a microprocessor device. System memory 107 may include both a read-only memory (ROM) 109 and a random access memory (RAM) 111. As will be appreciated by those of ordinary skill in the art, both read-only memory (ROM) 109 and random access memory (RAM) 111 may store software instructions to be executed by processing unit 105.

Processing unit 105 and system memory 107 are connected, either directly or indirectly, through a bus 113 or alternate communication structure to one or more peripheral devices. For example, processing unit 105 or system memory 107 may be directly or indirectly connected to additional memory storage, such as a hard disk drive 117, a removable optical disk drive 119, a removable magnetic disk drive 125, and a flash memory card 127. Processing unit 105 and system memory 107 also may be directly or indirectly connected to one or more input devices 121 and one or more output devices 123.

Output devices 123 may include, for example, a monitor display, an integrated display 192, television, printer, stereo, or speakers. Input devices 121 may include, for example, a keyboard, touch screen, a remote control pad, a pointing device (such as a mouse, touchpad, stylus, trackball, or joystick), a scanner, a microphone, or a camera.

More specifically, in the presently described gesture recognition systems, input devices 121 include at least a camera 122 (e.g., a light camera, a thermographic camera, etc.). In one example, camera 122 is a visible light digital camera. The visible light digital camera uses an optical system including a lens and a variable diaphragm to focus light onto an electronic image pickup device. The visible light digital camera can be a compact digital camera, a bridge camera, a mirrorless interchangeable-lens camera, a modular camera, a digital single-lens reflex camera, digital single-lens translucent camera, line-scan camera, etc. Further, it will be appreciated that the visible light digital camera can be any known or yet to be discovered visible light digital camera.

In one embodiment, camera 122 is integral to the computing device 101. In another embodiment, camera 122 is remote of the computing device 101.

As mentioned above, camera 122 can additionally or alternatively be a thermographic camera or infrared (IR) camera. The IR camera can detect heat radiation in a way similar to the way an ordinary camera detects visible light. This makes IR cameras useful for gesture recognition in “normal light”, “low light”, and/or “no light” conditions. The IR camera can include cooled infrared photodetectors (e.g. indium antimonide, indium arsenide, mercury cadmium telluride, lead sulfide, lead selenide, etc.) and/or uncooled infrared photodetectors (e.g., vanadium oxide, lanthanum barium manganite, amorphous silicon, lead zirconate titanate, lanthanum doped lead zirconate titanate, lead scandium tantalate, lean lanthanum titanate, lead titanate, lead zinc niobate, lead strontium titanate, barium strontium titanate, antimony sulfoiodide, polyvinylidene difluoride, etc.). Further, it will be appreciated that the IR camera can be any known or yet to be discovered thermographic camera.

Returning to FIG. 13, computing unit 103 can be directly or indirectly connected to one or more network interfaces 115 for communicating with a network. This type of network interface 115, also sometimes referred to as a network adapter or network interface card (NIC), translates data and control signals from computing unit 103 into network messages according to one or more communication protocols, such as the Transmission Control Protocol (TCP), the Internet Protocol (IP), and the User Datagram Protocol (UDP). These protocols are well known in the art, and thus will not be discussed here in more detail. An interface 115 may employ any suitable connection agent for connecting to a network, including, for example, a wireless transceiver, a power line adapter, a modem, or an Ethernet connection.

Computing device 101 may be connected to or otherwise comprise one or more other peripheral devices. In one example, computing device 101 may be comprise a telephone. The telephone may be, for example, a wireless “smart phone,” such as those featuring the Android or iOS operating systems. As known in the art, this type of telephone communicates through a wireless network using radio frequency transmissions. In addition to simple communication functionality, a “smart phone” may also provide a user with one or more data management functions, such as sending, receiving and viewing electronic messages (e.g., electronic mail messages, SMS text messages, etc.), recording or playing back sound files, recording or playing back image files (e.g., still picture or moving video image files), viewing and editing files with text (e.g., Microsoft Word or Excel files, or Adobe Acrobat files), etc.

Of course, still other peripheral devices may be included with or otherwise connected to a computing device 101 of the type illustrated in FIG. 13, as is well known in the art. In some cases, a peripheral device may be permanently or semi-permanently connected to computing unit 103. For example, with many computing devices, computing unit 103, hard disk drive 117, removable optical disk drive 119 and a display are semi-permanently encased in a single housing.

Still other peripheral devices may be removably connected to computing device 101, however. Computing device 101 may include, for example, one or more communication ports through which a peripheral device can be connected to computing unit 103 (either directly or indirectly through bus 113). These communication ports may thus include a parallel bus port or a serial bus port, such as a serial bus port using the Universal Serial Bus (USB) standard or the IEEE 1394 High Speed Serial Bus standard (e.g., a Firewire port). Alternately or additionally, computing device 101 may include a wireless data “port,” such as a Bluetooth® interface, a Wi-Fi interface, an infrared data port, or the like.

It will be appreciated that a computing device employed according various examples of the invention may include more components than computing device 101 illustrated in FIG. 13, fewer components than computing device 101, or a different combination of components than computing device 101. Some implementations of the invention, for example, may employ one or more computing devices that are intended to have a very specific functionality, such as a server computer. These computing devices may thus omit unnecessary peripherals, such as the network interface 115, removable optical disk drive 119, printers, scanners, external hard drives, etc. Some implementations of the invention may alternately or additionally employ computing devices that are intended to be capable of a wide variety of functions, such as a desktop or laptop personal computer, tablet and/or smartphone. These computing devices may have any combination of peripheral devices or additional components as desired.

In many examples, computing devices may comprise mobile electronic devices, such as smart phones, smart glasses, tablet computers, or portable music players, often operating the iOS, Symbian, Windows-based (including Windows Mobile and Windows 8), or Android operating systems.

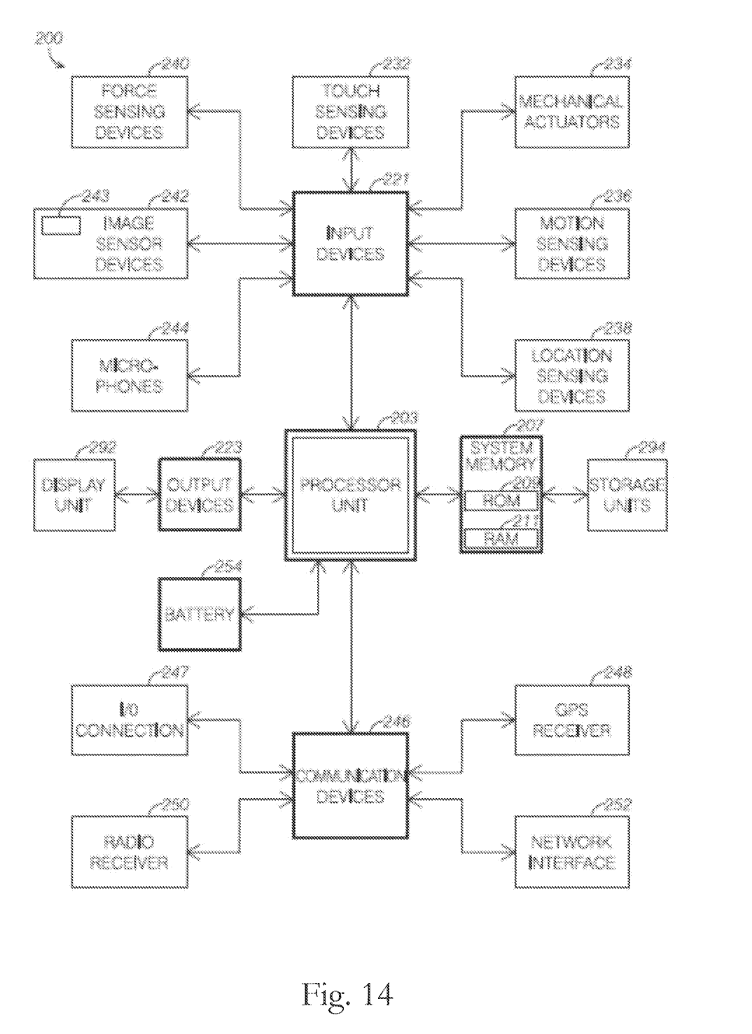

With reference to FIG. 14, an exemplary computing device, mobile device 200 is shown. Thus, mobile device 200 may include similar or identical features to computing device 101. In one example, mobile device 200 may include a processor unit 203 (e.g., CPU) configured to execute instructions and to carry out operations associated with the mobile device. For example, using instructions retrieved from memory, the controller may control the reception and manipulation of input and output data between components of the mobile device. The controller can be implemented on a single chip, multiple chips or multiple electrical components. For example, various architectures can be used for the controller, including dedicated or embedded processor, single purpose processor, controller, ASIC, etc. By way of example, the controller may include microprocessors, DSP, A/D converters, D/A converters, compression, decompression, etc.

In most cases, the controller together with an operating system operates to execute computer code and produce and use data. The operating system may correspond to well-known operating systems such iOS, Symbian, Windows-based (including Windows Mobile and Windows 8), or Android operating systems, or alternatively to special purpose operating system, such as those used for limited purpose appliance-type devices. The operating system, other computer code and data may reside within a system memory 207 that is operatively coupled to the controller. System memory 207 generally provides a place to store computer code and data that are used by the mobile device. By way of example, system memory 207 may include read-only memory (ROM) 209, random-access memory (RAM) 211. Further, system memory 207 may retrieve data from storage units 294, which may include a hard disk drive, flash memory, etc. In conjunction with system memory 207, storage units 294 may include a removable storage device such as an optical disc player that receives and plays DVDs, or card slots for receiving mediums such as memory cards (or memory sticks).

Mobile device 200 also includes input devices 221 that are operatively coupled to processor unit 203. Input devices 221 are configured to transfer data from the outside world into mobile device 200. As shown, input devices 221 may correspond to both data entry mechanisms and data capture mechanisms. In particular, input devices 221 may include touch sensing devices 232 such as touch screens, touch pads and touch sensing surfaces, mechanical actuators 234 such as button or wheels or hold switches, motion sensing devices 236 such as accelerometers, location detecting devices 238 such as global positioning satellite transmitters, WiFi based location detection functionality, or cellular radio based location detection functionality, force sensing devices 240 such as force sensitive displays and housings, image sensors 242 such as light cameras and/or IR cameras, and microphones 244. Input devices 221 may also include a clickable display actuator.

More specifically, in the presently described gesture recognition systems, input devices 221 include at least a camera 243 (one of image sensing devices 242). Camera 243 can be a visible light camera and/or a thermographic camera, such as those described above in reference to camera 122. Accordingly, camera 243 may have the same functions and capabilities as those described above in reference to camera 122.

Returning to FIG. 14, mobile device 200 also includes various output devices 223 that are operatively coupled to processor unit 203. Output devices 223 are configured to transfer data from mobile device 200 to the outside world. Output devices 223 may include a display unit 292 such as an LCD, speakers or jacks, audio/tactile feedback devices, light indicators, and the like.

Mobile device 200 also includes various communication devices 246 that are operatively coupled to the controller. Communication devices 246 may, for example, include both an I/O connection 247 that may be wired or wirelessly connected to selected devices such as through IR, USB, or Firewire protocols, a global positioning satellite receiver 248, and a radio receiver 250 which may be configured to communicate over wireless phone and data connections. Communication devices 246 may also include a network interface 252 configured to communicate with a computer network through various means which may include wireless connectivity to a local wireless network, a wireless data connection to a cellular data network, a wired connection to a local or wide area computer network, or other suitable means for transmitting data over a computer network.

In some embodiments, mobile device 200 may include a battery 254 and a charging system. Battery 254 may be charged through a transformer and power cord or through a host device or through a docking station. In the cases of the docking station, the charging may be transmitted through electrical ports or through an inductance charging means that does not require a physical electrical connection to be made.

In one embodiment, mobile device 200 may comprise touch screen 232, processor 203, audio output device 223, data storage device 294, camera 243, and audio input device 244. Touch screen 232 may be configured to receive at least a first and a second location-independent gesture from a user of mobile device 200. As discussed above, the user may be blind or seeing-impaired. Processor 203 may be configured to translate the first location-independent gesture into a first computer-readable instruction. Processor 203 may be configured to translate the second location-independent gesture into a second computer-readable instruction. Processor 203 may be configured to execute the computer-readable instruction. Audio output device 223 may be configured to provide, in response to the first computer-readable instruction, an audio response to the user.

In one embodiment, data storage device 294 may be configured to store at least one text file encoding words. Processor 203 may be configured to interpret the at least one text files provide instructions to the audio output device 223. Audio output device 223 may be configured to broadcast the words encoded in the at least one text file in response to the instructions.

In one embodiment, camera 243 may be configured to capture at least one image. Processor 203 may be configured analyze the image and to recognize a color in the image, recognize a banknote in the image, and/or magnify at least a portion of the image.

In one embodiment, audio input device 244 may be configured to capture at least one audio recording. Data storage device 294 may be configured to store the at least one audio recording.

The various aspects, features, embodiments or implementations described above can be used alone or in various combinations with the gesture recognition methods disclosed herein. The methods disclosed herein can be implemented by software, hardware or a combination of hardware and software. The methods can also be embodied as computer readable code on a computer readable medium (e.g. a non-transitory computer readable-storage medium). The computer readable medium is any data storage device that can store data which can thereafter be read by a computer system, including both transfer and non-transfer devices as defined above. Examples of the computer readable medium include read-only memory, random access memory, CD-ROMs, flash memory cards, DVDs, magnetic tape, optical data storage devices, and carrier waves. The computer readable medium can also be distributed over network-coupled computer systems so that the computer readable code is stored and executed in a distributed fashion.

The disclosure above encompasses multiple distinct inventions with independent utility. While each of these inventions has been disclosed in a particular form, the specific embodiments disclosed and illustrated above are not to be considered in a limiting sense as numerous variations are possible. The subject matter of the inventions includes all novel and non-obvious combinations and subcombinations of the various elements, features, functions and/or properties disclosed above and inherent to those skilled in the art pertaining to such inventions. Where the disclosure or subsequently filed claims recite “a” element, “a first” element, or any such equivalent term, the disclosure or claims should be understood to incorporate one or more such elements, neither requiring nor excluding two or more such elements.

Applicant(s) reserves the right to submit claims directed to combinations and subcombinations of the disclosed inventions that are believed to be novel and non-obvious. Inventions embodied in other combinations and subcombinations of features, functions, elements and/or properties may be claimed through amendment of those claims or presentation of new claims in the present application or in a related application. Such amended or new claims, whether they are directed to the same invention or a different invention and whether they are different, broader, narrower or equal in scope to the original claims, are to be considered within the subject matter of the inventions described herein.

1. A method of interacting with a mobile device, the method comprising
(a) receiving a first location-independent gesture from a user via a touch screen of the mobile device;
wherein the user is seeing-impaired;
(b) translating the first location-independent gesture into a first computer-readable instruction via a processor of the mobile device;
(c) providing, in response to the first computer-readable instruction, an audio response to the user via an audio output device of the mobile device;
(d) receiving, in response to the audio response, a second location-independent gesture from the user via the touch screen;
(e) translating the second location-independent gesture into a second computer-readable instruction via the processor of the mobile device;
(f) executing, in response to the translating step (e), the second computer readable instruction via the processor of the mobile device.

2. The method of claim 1, wherein the first location-independent gesture is different than the second location-independent gesture.

3. The method of claim 1, wherein the first and second location-independent gestures are selected from the group consisting of:
a one-finger tap on the right side of the touch screen;
a one-finger tap on the left side of the touch screen;
a one-finger push anywhere on the touch screen;
a two-finger tap anywhere on the touch screen;
a two-finger push anywhere on the touch screen; and
a one-finger swipe from the bottom of the touch screen to the top.

4. The method of claim 3, wherein a push is a contact of the touch screen having a duration of at least 300 milliseconds second.

5. The method of claim 1, comprising taping a power button of the mobile device in order to access a help mode.

6. The method of claim 3, wherein a one-finger tap on the right side of the touch screen is translated into a computer-readable instruction to advance to a next item in a navigation menu of the mobile device.

7. The method of claim 3, wherein a one-finger tap on the left side of the touch screen is translated into a computer-readable instruction to revert to a previous next item in a navigation menu of the mobile device.

8. The method of claim 3, wherein a one-finger push is translated into a computer-readable instruction to confirm a current next item in a navigation menu of the mobile device when the mobile device is in a menu navigation mode.

9. The method of claim 8, wherein a one-finger push is translated into a computer-readable instruction to answer a call when the mobile device is in a phone mode.

10. The method of claim 8, wherein a one-finger push is translated into a computer-readable instruction to stop an alarm when mobile device is in an alarm mode.

11. The method of claim 3, wherein a two-finger tap is translated into a computer-readable instruction to repeat an audio response when the mobile device is in a menu navigation mode.

12. The method of claim 11, wherein a two-finger tap is translated into a computer-readable instruction to provide audio caller information when the mobile device is in a phone mode.

13. The method of claim 3, wherein a two-finger push is translated into a computer-readable instruction to revert to a previous menu when the mobile device is in a menu navigation mode.

14. The method of claim 13, wherein a two-finger push is translated into a computer-readable instruction to dismiss an incoming call when the mobile device is in a phone mode.

15. The method of claim 13, wherein a two-finger push is translated into a computer-readable instruction to snooze an alarm when the mobile device is in an alarm mode.

16. The method of claim 1, wherein the first computer readable instruction is an instruction to navigate in a menu, wherein the menu is selected from the group comprising:
alarm mode;
text mode;
phone mode;
voice record mode;
calendar mode;
book reader mode;
banknote recognition mode;
magnification mode;
color indication mode; and
calculator mode.

17. A mobile device comprising
a touch screen configured to receive at least a first and a second location-independent gesture from a user of the mobile device;
wherein the user is seeing-impaired.
a processor configured to:
translate the first location-independent gesture into a first computer-readable instruction;
translate the second location-independent gesture into a second computer-readable instruction;
execute the computer-readable instruction; and
an audio output device configured to provide, in response to the first computer-readable instruction, an audio response to the user via an audio output of the mobile device.

18. The mobile device of claim 17 comprising:
a data storage device configured to store at least one text file encoding words;
wherein the processor is configured to interpret the at least one text files provide instructions to the audio output device; and
wherein the audio output device is configured to broadcast the words encoded in the at least one text file in response to the instructions.

19. The mobile device of claim 17 comprising:
a camera configured to capture at least one image; and
wherein the processor is configured to:
recognize a color in the image;
recognize a banknote in the image; and
magnify the image.

20. The mobile device of claim 17 comprising:
an audio input device configured to capture at least one audio recording, and
a data storage device configured to store the at least one audio recording.
